(19) United States
(12) Patent Application Publication
(10) Pub. No.: US 2019/0192887 A1
(43) Pub. Date: Jun. 27, 2019

(54) ASSEMBLY FOR EXTRICATION AND RESCUE

(71) Applicant: Strategic Rescue Products, LLC, Cable, WI (US)

(72) Inventors: Carole L. Christianson, Plymouth, MN (US); Mark S. Christianson, Plymouth, MN (US)

(21) Appl. No.: 16/101,289

(22) Filed: Aug. 10, 2018

Related U.S. Application Data
(63) Continuation-in-part of application No. 15/970,137, filed on May 3, 2018.
(60) Provisional application No. 62/608,867, filed on Dec. 21, 2017.

(51) Int. Cl. A62B 35/00

(52) U.S. Cl. CPC A62B 35/0006

(57) ABSTRACT

A tactical extrication and rescue assembly comprises a base member having at least one mounting element for securing said base member to an article of clothing or gear; and a rescue strap releasably secured to and storable within the base member, the rescue strap including left and right end portions each including a graspable handle member, an end strap segment with a couple member, and a deployment and attachment mechanism that allows the graspable handle member and the end segment to be attached and deployed adjacent to one another when the rescue strap is deployed from the tactical extrication and rescue assembly, enabling the couple members to be adjacent to the rescuer's hands for quicker and easier coupling of the coupling members so that a secure connection to a rescuee is formed for extrication and rescue.

### CROSS-REFERENCE TO RELATED APPLICATIONS

This application is a continuation-in-part of U.S. patent application Ser. No. 15/970,137 filed May 3, 2018, which claims priority to U.S. provisional patent application No. 62/608,867 filed Dec. 21, 2017, both of which are incorporated by reference herein.

### FIELD OF THE INVENTION

This disclosure relates to systems, assemblies and methods for extrication and rescue. In particular, this disclosure relates to a wearable assembly having deployable implements for securing a distressed or disabled person to a wearer of the assembly.

### BACKGROUND OF THE INVENTION

Those employed in firefighting, law enforcement, military entities and other similar professions can be put in harm's way by the very nature of their occupation. In many cases, these people train to be prepared for emergency situations which may involve self-extrication or the extrication of others, including co-workers.

For example, firefighters frequently train to be efficient in rescue operations for a range of circumstances, including extricating persons from vehicles, dwellings, businesses and other situations. A variety of equipment is available to rescue personnel to both protect the patient and aid rescuers in rapidly and efficiently removing persons from danger. A need still exists, however, for wearable, low-profile rescue equipment capable of providing rescue resources for a wide variety of circumstances

The world has seen an unprecedented increase in the number of so-called ‘active shooter’ scenarios where one or more assailants attempt to maximize casualties in civilian settings. The sequence of events in such scenarios is tragically similar: one or more gunmen enter a building or venue and begin to inflict harm against as many people as possible, often choosing targets at random. Law enforcement and rescue personnel must work through an initial period of chaos where, simultaneously an evacuation may be underway, the assailants must be identified and neutralized, and rescue of those injured must be initiated.

In many jurisdictions, the responsibility of law enforcement and rescue are split between police and fire/rescue agencies, respectively. In many active shooter scenarios, law enforcement agencies (police, SWAT teams, National Guard, etc.) are focused on neutralizing the person or persons inflicting harm, while paramedics, fire fighters, EMT's, etc. assume responsibility for victim treatment.

It can be increasingly dangerous for personnel of any one agency to assume dual responsibility of both threat neutralization and victim search and recovery. For example, if a SWAT team member encounters a viable victim during a search for the perpetrator, that officer increases his own risk of being injured if he must use his hands to drag the victim to a safe location. In such a scenario, the officer would likely holster his weapon to be able to drag the victim, thus exposing himself to danger if the perpetrator is encountered.

WO2016/166606 discloses a rescue assembly for rapid extrication of a victim from a dangerous environment. The rescue assembly includes a wearable base member and a rescue strap deployable therefrom. The rescue strap extends outwardly from the base member allowing a rescuer to form a secure connection to a rescuee for extrication. Keeper assemblies cooperatively retain the rescue strap within the base member until deployed by the rescuer and a release assembly provides the ability to quickly release the rescue strap from the base member if desired by the rescuer.

### SUMMARY

Improvements to the rescue assembly of WO2016/166606 are shown and described here.

An aspect of the invention includes A tactical extrication and rescue assembly including a base member including opposite longitudinal ends, said base member comprising at least one mounting element for securing said base member to an article of clothing or gear; a quick de-coupling mechanism; a rescue strap releasably secured to the base member via the quick de-coupling mechanism at one of the opposite longitudinal ends of the base, the first and second end portions including respective first and second connection members; wherein said base member is configured to contain said rescue strap in a pre-deployed configuration wherein left and right end portions of said rescue strap extend exteriorly from said base member to form graspable handle members for deploying said rescue strap, said quick de-coupling mechanism at the longitudinal end base ensures that the quick de-coupling mechanism falls out of the side of the base during use so that a rescuer can easily and readily locate and operate the quick de-coupling mechanism in an emergency, allowing the rescuer to quickly de-couple the rescue strap from the base and, thereby, the rescuer.

One or more implementations of the aspect of the invention described immediately above includes one or more of the following: the quick de-coupling mechanism includes a snap shackle, a release mechanism, and a pull cord to operate the quick de-coupling mechanism; the left and right end portions of said rescue strap are not fastened into the ends of the base, making the rescue strap quick and easy to deploy in an emergency; the base includes an exterior and the rescue strap includes left and right wings portions that are detachable and attachable to the exterior of the base; the base includes an exterior and the left and right end portions of the rescue strap include left and right wing portions that are detachable and attachable to the exterior of the base; the left and right wing portions extend exteriorly from said base member to form graspable handle members for deploying said rescue strap; the tactical extrication and rescue assembly is integrated into one or more of clothing, gear, and other items worn by law enforcement, firefighters, military personnel, and others; the tactical extrication and rescue assembly is integrated into a backpack; the tactical extrication and rescue assembly is integrated into a gun belt; and/or the base member is configured to be attached to MOLLE or ALICE equipment or an SCBA assembly.

Another aspect of the invention involves a method of packing the tactical extrication and rescue assembly of the aspect of the invention described above. The method includes the steps of providing the base in an open position, the base including a flap extending laterally outward from the base; bunching the rescue strap together; placing the bunched rescue strap in the open base with the left and right end portions extending out of the longitudinal ends of the base; placing the flap over the bunched rescue strap; and rolling the base with flap over the bunched rescue strap like rolling a burrito.

An additional aspect of the invention involves a tactical extrication and rescue assembly comprising a base member having at least one mounting element for securing said base member to an article of clothing or gear; and a rescue strap releasably secured to and storable within the base member, the rescue strap including left and right end portions each including a graspable handle member, an end strap segment with a couple member, and a deployment and attachment mechanism that allows the graspable handle member and the end segment to be attached and deployed adjacent to one another when the rescue strap is deployed from the tactical extrication and rescue assembly, enabling the couple members to be adjacent to the rescuer's hands for quicker and easier coupling of the coupling members so that a secure connection to a rescuee is formed for extrication and rescue.

One or more implementations of the aspect of the invention described immediately above including one or more of the following: he coupling members include one or more of a snap shackle, a loop, and a carabiner; the base includes a recess that the rescue strap is storable within and a protective flap that covers the base, the protective flap having a pull tab; the rescue strap includes a proximal end, and at least one of the base and the proximal end includes a modular attachment member to attach the proximal end of the rescue strap to base; the base includes one or more attachment mechanisms to couple the base to one or more of a tactical vest, a firefighter self-contained breathing apparatus (SCBA), firefighter turn-out jacket, MOLLE assembly, belt, and other gear; the one or more attachment mechanisms include a strap; the one or more attachment mechanisms include at least one of hook fasteners and loop fasteners; the one or more attachment mechanisms include at least one magnet; the one or more attachment mechanisms include a modular attachment member; one or more snap connectors to releasably secure the graspable handle members to the base; and/or hook and loop fasteners to releasably secure the graspable handle members to the base.

Another aspect of the invention involves a method of using the tactical extrication and rescue assembly of the aspect of the invention or one or more implementations of the aspect of the invention described immediately above, comprising: storing the rescue strap in the base member when not in use; and deploying the rescue strap from the base member by grasping the handle members of the left and right end portions of the rescue strap and pulling the rescue strap out of the base member so that the graspable handle member and the end segment are attached to one another and deployed adjacent one another when the rescue strap is deployed, enabling the couple members to be adjacent to the rescuer's hands for quicker and easier coupling of the coupling members so that a secure connection to a rescuee is formed for extrication and rescue.

### BRIEF DESCRIPTION OF DRAWINGS

FIG. 1 is a rear-side view of a tactical extrication and rescue assembly (TERA), according to one embodiment;

FIG. 2 is a front-side view of the TERA shown in FIG. 1;

FIG. 3 is a side view showing internal components of the TERA of FIG. 1;

FIG. 4 is a magnified view of internal components of the TERA of FIG. 1;

FIG. 5 shows the TERA of FIG. 1 in an open configuration;

FIG. 6 shows the TERA of FIG. 1 in an open configuration with the rescue strap shown slightly extended/deployed;

FIG. 7 shows the TERA of FIG. 1 in an open configuration with the rescue strap shown more extended/deployed compared to FIG. 6;

FIG. 8 shows an enlarged view of a snap shackle in a locked condition for securing the rescue strap to the base;

FIG. 9 shows an enlarged view of the snap shackle in an unlocked condition for quick release of the rescue strap from the base;

FIG. 10 illustrates an exemplary use of the TERA for rapid extrication of a victim;

FIG. 11 illustrates a TERA integrated into a backpack, according to an embodiment; and

FIG. 12 illustrates a TERA integrated into a gun belt, according to an embodiment.

FIG. 13 is a perspective view of a tactical extrication and rescue assembly (TERA), according to another embodiment;

FIG. 14 is a perspective view of a tactical extrication and rescue assembly (TERA), according to a further embodiment;

FIG. 15 is a rear-side view of a tactical extrication and rescue assembly (TERA), and shows an embodiment of an attachment mechanism;

FIG. 16 is a rear-side view of a tactical extrication and rescue assembly (TERA), and shows another embodiment of an attachment mechanism;

FIG. 17 is a rear-side view of a tactical extrication and rescue assembly (TERA), and shows an additional embodiment of an attachment mechanism;

FIG. 18 is a rear-side view of a tactical extrication and rescue assembly (TERA), and shows an additional embodiment of a strap attachment mechanism;

FIG. 19 is a front elevational view of a tactical extrication and rescue assembly (TERA), and shows an additional embodiment of deployment and attachment mechanism;

FIG. 20 is a front elevational view of a tactical extrication and rescue assembly (TERA), similar to FIG. 19, and shows the deployment and attachment mechanism of FIG. 19.

### DETAILED DESCRIPTION OF THE INVENTION

In general, a tactical extrication and rescue assembly (hereinafter ‘TERA’) is described. As will be apparent from the figures and description that follow, a TERA can be used by law enforcement, military, fire, ambulance or other personnel of similar professions to aid in the extrication of victims from a dangerous environment. In particular, TERAs of the type described herein allow a wearer to rapidly remove a victim from a dangerous environment while keeping the wearer's hands free to hold a weapon for providing cover or returning gunfire (in, e.g., police or military applications), for stability in low- or no-visibility environments (e.g., in firefighting applications) or any other purpose. In particular, a TERA provides the capability of a ‘hands-free’ removal of persons from a variety of dangerous environments, e.g., hostage or active-shooter situations, fires, IDLH (immediately dangerous to life and health) environments and others.

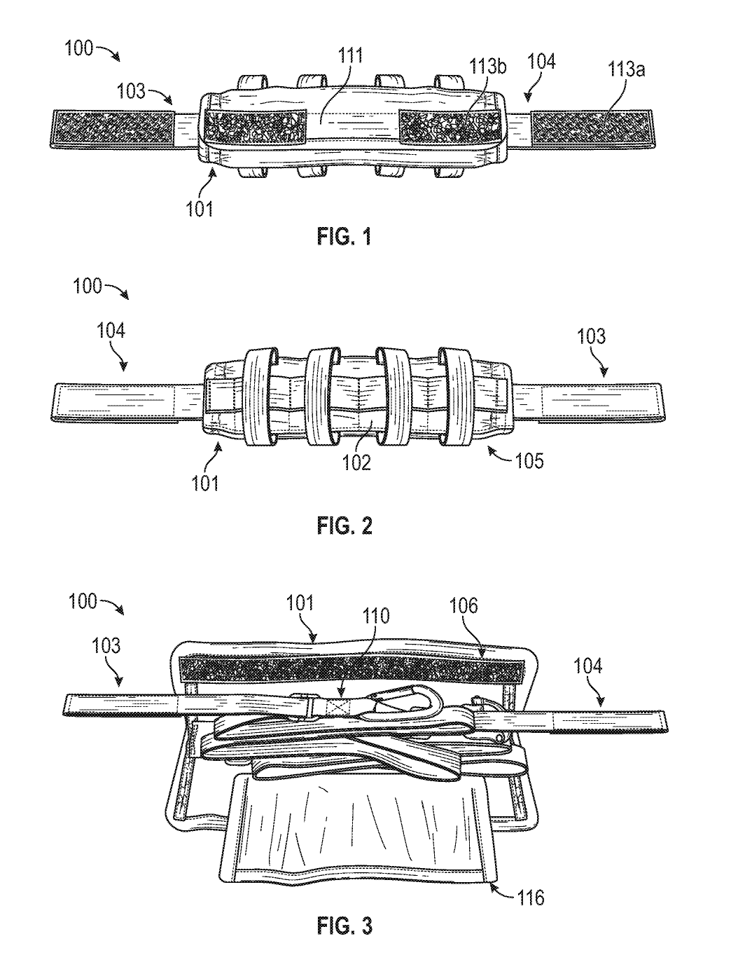

Referring now to FIGS. 1 and 2, rear and front sides of a TERA 100 are shown, respectively, according to one embodiment. In this embodiment, the TERA 100 includes a base 101 made from a flexible, resilient fabric such as Nylon, although other fabrics and materials can be substituted as desired to meet design, functionality, weight, moisture repellency, camouflage or other considerations. In this embodiment, the front side of the base 101 (shown in FIG. 2) includes pouch attachment ladder system (PALS) webbing 105 to enable the TERA 100 to be attached to various types of modular lightweight load-carrying equipment (MOLLE) gear and other tactical equipment used by, e.g., police, military, EMS and firefighting personnel. PALS webbing 105 is one of many options that can be used to attach TERA 100 to various equipment; other options include, but are not limited to: snaps, buckles and ties. In an alternative embodiment, TERA 100 can be integrally attached to equipment, clothing, gear, backpacks, gun belts, or other wearables through stitching or other approaches.

TERAs of the type described herein are generally configured to be worn by a wearer (e.g., a police officer, SWAT officer, firefighter or soldier) in a compact, pre-deployed configuration, illustrated, for example, in FIGS. 1 and 2, out of the way of other tools, garments or other gear until a rescue or extrication is to be performed.

In this embodiment, base 101 is configured to retain most of the person-to-person coupling implements of the TERA, such as straps, buckles and the like as described herein, neatly and securely stored in a pre-deployed configuration shown in FIGS. 1 and 2 until rescue or extrication is to be performed.

FIGS. 1 and 2 illustrate rear and front sides respectively of TERA 100 in an assembled, pre-deployed configuration. In this embodiment, left 103 and right 104 graspable handle members are formed from end portions of a continuous length of rescue strap 110 (FIG. 3). In the pre-deployed configuration shown in FIGS. 1 and 2, the left 103 and right 104 graspable handle members extend beyond the left and right sides of the base 101 as shown. The left 103 and right 104 graspable handle members and rear 111 of the base 101 include hook-and-loop fastening material such as those sold under the VELCRO® brand (Velcro Industries, Manchester, N.H.) 113a, 113b to secure the left 103 and right 104 graspable handle members to the base 101 when not in use. The left 103 and right 104 graspable handle members may be pulled out for pre-deployment as shown in FIGS. 1 and 2. In use, the TERA 100 can be attached to, e.g., a MOLLE vest, such that the side 102 of the TERA 100 faces towards the wearer's body. In the assembled, pre-deployed configuration shown in FIGS. 1 and 2, the base 101 is folded together as to substantially encapsulate the rescue strap 110 there within with the exception of left 103 and right 104 graspable handle members.

Referring now to FIG. 3, in this embodiment, hook-and-loop fastener components are configured to releasably secure the base 101 in the pre-deployed configuration. In this embodiment, a length of hook/loop material 106 is disposed along a top edge of the base 101 and a length of loop/hook material (not shown) is disposed along the bottom edge of the base 101 on an opposite side. Also, a flap 116 is attached to an inside of the base 101. In use, to re-package/re-install the TERA 100, the strap 110 and carabineer-type coupler 112/snap shackle 114 are bunched and/or folded into the configuration shown in FIG. 3 along the inside of the base 101, flap 116 is then disposed over the strap 110 and carabineer-type coupler 112/snap shackle 114. Then, the base 101 is rolled together, like rolling a burrito, by rolling low portion 123 over the flap 116, the strap 110 and carabineer-type coupler 112/snap shackle 114, and is continued to roll until the hook/loop material 106 disposed along the top edge of the base 101 is aligned with the loop/hook material (not shown) on the bottom edge of the base 101 (on an opposite side). The edges of the base 101 are then secured together with the hook/loop material, and the left 103 and right 104 graspable handle members are fastened via the hook-and-loop fastening material 113a, 113b to the rear 111 of the base 101 to secure the left 103 and right 104 graspable handle members to the base 101 when not in use. The base 101 of the TERA 100 can be opened easily by unfastening the hook-and-loop fastening material of the base to access the rescue strap 110 for inspection, re-packing or to perform other actions.

Tactical maneuvers performed by, e.g., police, SWAT, EMS, military and firefighting personnel are sometimes physically dynamic and demanding. As one will appreciate, it is generally important that, e.g., police officers' and firefighters' gear not become semi- or completely dislodged when running, climbing, engaging suspects in a physical confrontation or performing other maneuvers. Therefore, in this and other embodiments, base 101 is configured to securely retain rescue strap 110 until it is purposefully deployed as described below. In this embodiment, securement of the left 103 and right 104 graspable handle members of rescue strap 110 along the base 101 is accomplished using the hook-and-loop fastening components 113a, 113b. With the 103 and left 104 graspable handle members/wings of rescue strap 110 extending out of the base 101 and are attached to the outside of the base 101, the rescue strap 110 is more easily gripped and deployed by the rescuer. Other approaches and materials can be substituted according to preference or the type of physical activity that the wearer may be required to perform, such as through the use of buttons, snaps, ties or other approaches.

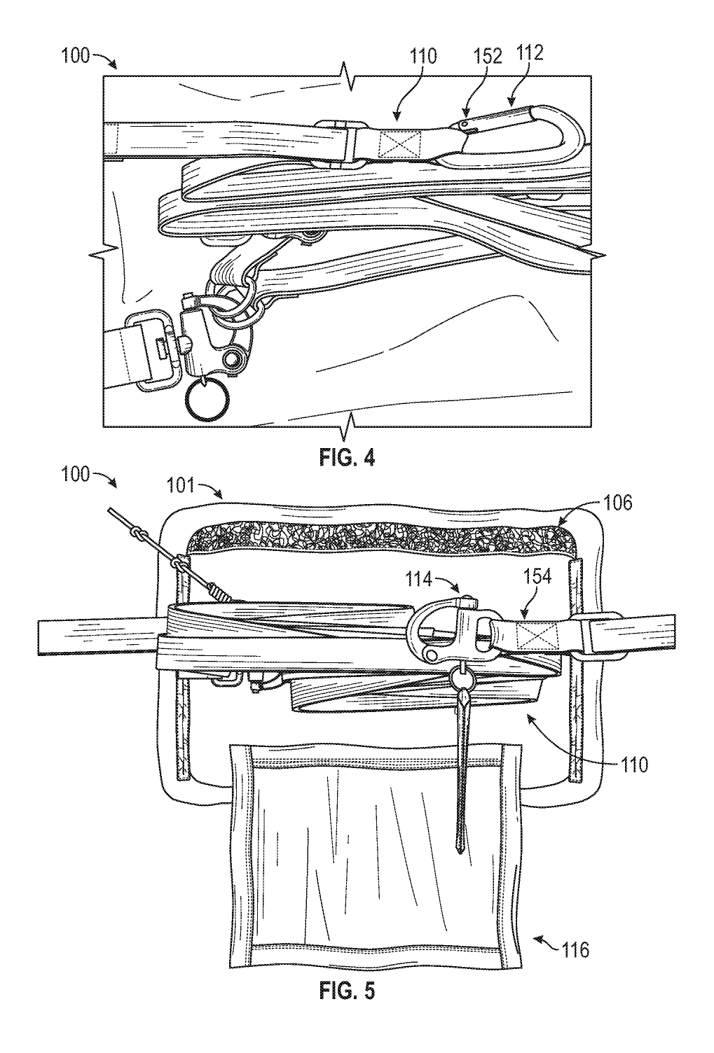

FIG. 4 illustrates the rescue strap 110 folded within the base 101 and the carabineer-type coupler 112 extending therefrom from one portion of the rescue strap 110.

FIG. 5 illustrates the interior of base 101 laid flat, in a fully opened and un-folded configuration showing the flap 116 open and another portion of the rescue strap 110 with snap shackle 114.

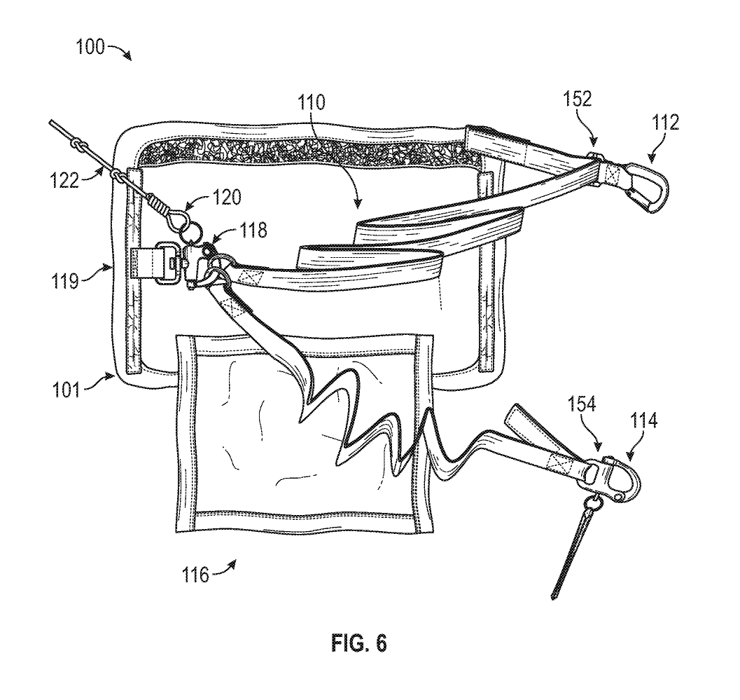

FIG. 6 illustrates the TERA 100 in an open configuration with the portions of the rescue strap 110 shown slightly extended/deployed.

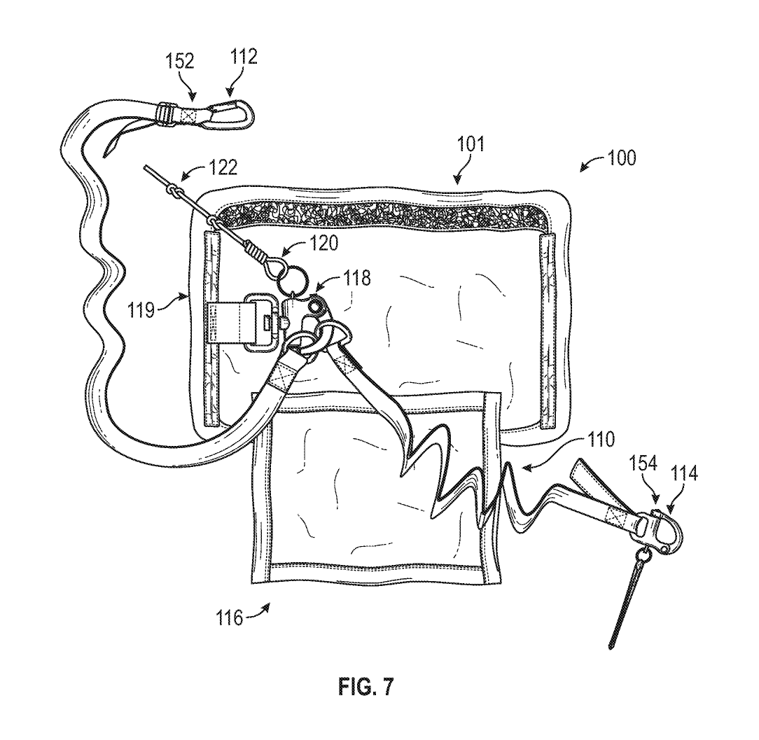

FIG. 7 shows the TERA 100 in an open configuration with the portions of the rescue strap 110 shown more extended/deployed compared to FIG. 6.

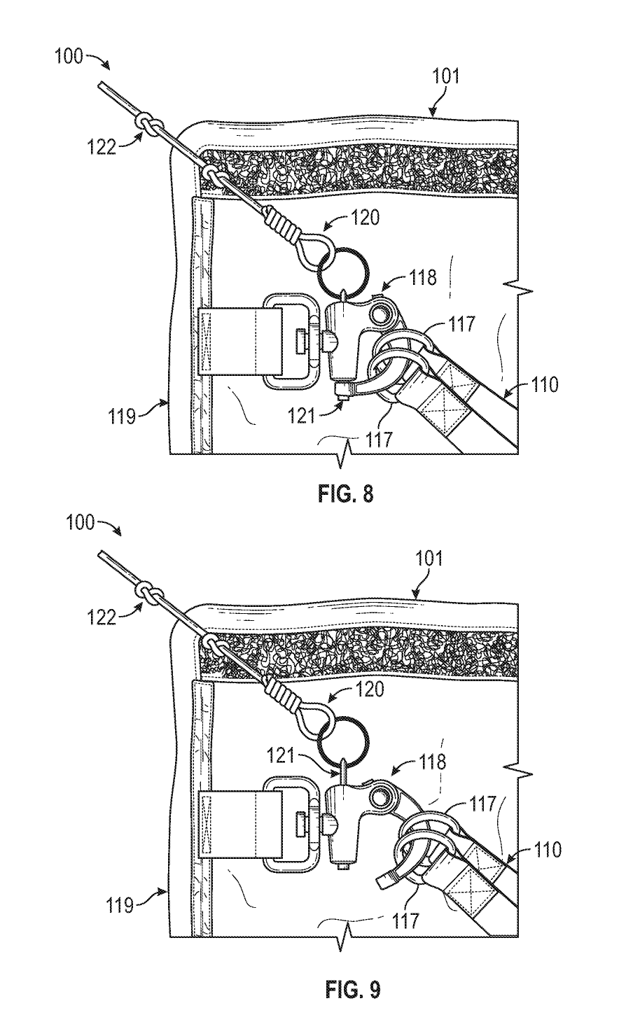

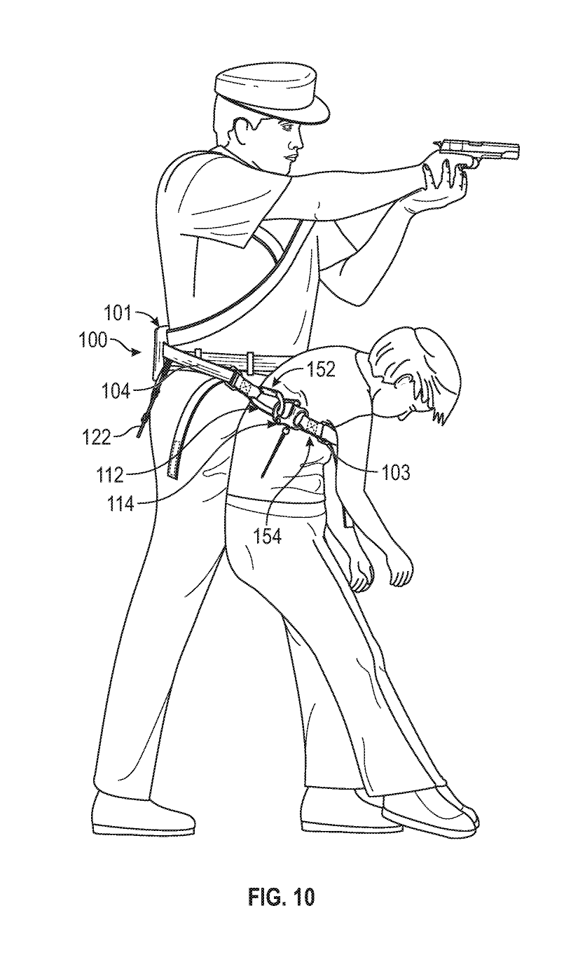

As shown in FIGS. 6-8, ends of the portions of the rescue strap 110 opposite of the carabineer-type coupler 112 and the snap shackle 114 include loops 117 that are releasably attached to snap shackle 118, which is disposed at a longitudinal end 119 of the base 101. Snap shackle 118 includes a release mechanism 120 (release pin 121 coupled to release pull cord 122 for quick de-coupling of the portions of the rescue strap 110 from the base 101, as shown in FIGS. 8 and 9. Although, snap shackle 118, release pin 121, release pull cord 122 are shown as an exemplary quick de-coupling mechanism for quickly de-coupling the rescue strap 110 from the base 101, in alternative embodiments, other types of quick de-coupling mechanisms may be provided for this purpose. It is advantageous to locate the quick de-coupling mechanism (e.g., snap shackle 118 and release mechanism 120) at the longitudinal end 119 of the base 101 to ensure that the quick de-coupling mechanism falls out of the side of the base 101 during use so that the rescuer can easily and readily locate the pull cord 122 and operate the quick de-coupling mechanism in an emergency. The quick de-coupling mechanism allows the rescuer to quickly de-couple the rescue strap 110 from the base 101 and, thereby, the rescuer. Such functionality can be beneficial, for example, in cases where a rescuer has extricated a rescuee from a dangerous environment, but needs to quickly decouple from the rescuee to perform additional rescue functions, search for suspects, provide medical attention to the rescuee or perform other actions.

In a preferred embodiment, the TERA 100 can be configured to be coupled to gear or clothing such that it can be worn on a user's back, where it is substantially out of the way of other wearable tactical components. In such an embodiment, the rescue strap 110 can be of sufficient length that it may be extended around the torso of the rescuer and the rescuee as described in greater detail below and shown, e.g., in FIG. 10.

Each of right 152 and left 154 end portions of the rescue strap 110 can include a coupling member so that the rescue strap 110 can be reversibly coupled to form a substantially continuous loop around the rescuer and the rescuee as shown, e.g., in FIG. 10. FIGS. 4-7 and 10 show an exemplary carabineer-type coupler 112 engaged to a right end portion 152 and a snap shackle 114 engaged to the right end portion 154. Each coupler can be engaged to the right 152 or left 154 end portion via, e.g., a position-adjustable slide, buckle, or other hardware. Snap shackle 114, which is similar to snap shackle 118 described above, includes a release handle attached to a release pin, which is coupled to a release pull cord 122, for quick de-coupling of right 152 and right 154 end portions of rescue strap 110. It should be understood that the carabineer-type coupler 112 and snap shackle 114 are two of many different types of coupling mechanisms that can be used for coupling right 152 and left 154 end portions together to form a substantially continuous loop of the rescue strap 110. Other couplers, fasteners and similar hardware can be substituted according to preference.

Similarly, the coupling members need not necessarily be configured to form a loop of the rescue strap 110. In other approaches, the length of the rescue strap 110 and the coupling hardware used can be configured for direct attachment onto clothing or gear of a rescuee. For example, a carabineer-type coupler 112 can be positioned on both the right 152 and left 154 end portions so that each end of the rescue strap 110 can be attached to a connection member on a tactical vest, firefighter self-contained breathing apparatus (SCBA) bracket, firefighter turn-out jacket, MOLLE assembly, belt or other gear.

In this embodiment, rescue strap 110 is of sufficient length so as to allow the rescuer to couple each end portion of the belt around a rescuee, e.g., around the torso, and further configured to provide a terminal end portion (graspable handle member/wing 103 or 104, or both) that the rescuer can grip and pull to tighten rescue strap 110 around himself and the rescuee. This allows the rescuer to provide a close body-to-body tandem connection which can, in turn, provide additional stability when extricating the rescuee by minimizing ‘swing’ between the two persons. When the TERA 100 is worn around the lower back, e.g., above the hips, the connection provides a low center-of-gravity that can reduce back injuries that otherwise may occur when a rescuer extricates a rescuee using his arm and upper body muscles.

Referring now to FIG. 10, TERA 100 is illustrated in an operable rescue/extrication configuration, being worn by a rescuer; in this example, a SWAT team member. In this example, TERA 100 is attached to the rescuer's MOLLE vest using PALS webbing as previously described (not illustrated). The rescuer has deployed right 152 and left 154 portions of rescue strap from base 101, extended them about the victim's upper torso and coupled the end portions together by engaging carabineer 112 with snap shackle 114. The coupling mechanisms of rescue strap 110, e.g., carabineer 112 and snap shackle 114, can be preferably attached medially to the victim, e.g., near the sternum so that the end portions can be uncoupled without encumbrance when desired. The rearward broken-line arrows in FIG. 10 indicate a direction of travel that the rescuer may take when performing extrication of the victim from a hostile or otherwise unsafe environment. By walking backwards, the rescuer can maintain optimal balance, use his weight to aid in pulling the victim (by leaning backwards and maximize leg muscle usage to avoid back injury. Furthermore, the extrication posture exemplified in FIG. 10 allows the rescuer to have his hands free, in this case, to provide weapons cover for himself and the victim.

FIG. 10 illustrates several features and advantages of the TERA 100. For example, the TERA 100 elevates the rescuee's body so that drag is minimized, which can reduce the effort required of the rescuer. In this example, only the feet of the victim touch the ground, thereby producing minimal drag. In another aspect, the rescuer may stand up straight and/or lean backwards while supporting the rescuee, which results in a proper center of gravity and thereby a more stable stance. In yet another aspect, the rescuer's hands are free, in this example to provide cover for himself and the rescuee, or to provide return fire if the pair are under attack. The rescuer is also free to use his hands for stability, to brace or lift himself, or perform any other act or motion requiring free hands while performing rescue. In yet another aspect, using the TERA 100 and the leverage provided by his body weight, the rescuer can perform rapid extrication of victims without the aid of a partner.

Continuing with the example shown in FIG. 10, should the need arise, the rescuer can detach himself from the rescuee by grasping release strap 122 and pulling outwardly, away from base 101. As described above, this action quickly results in right 152 and right 154 end portions decoupling from base 101, which effectively decouples rescuer and rescuee.

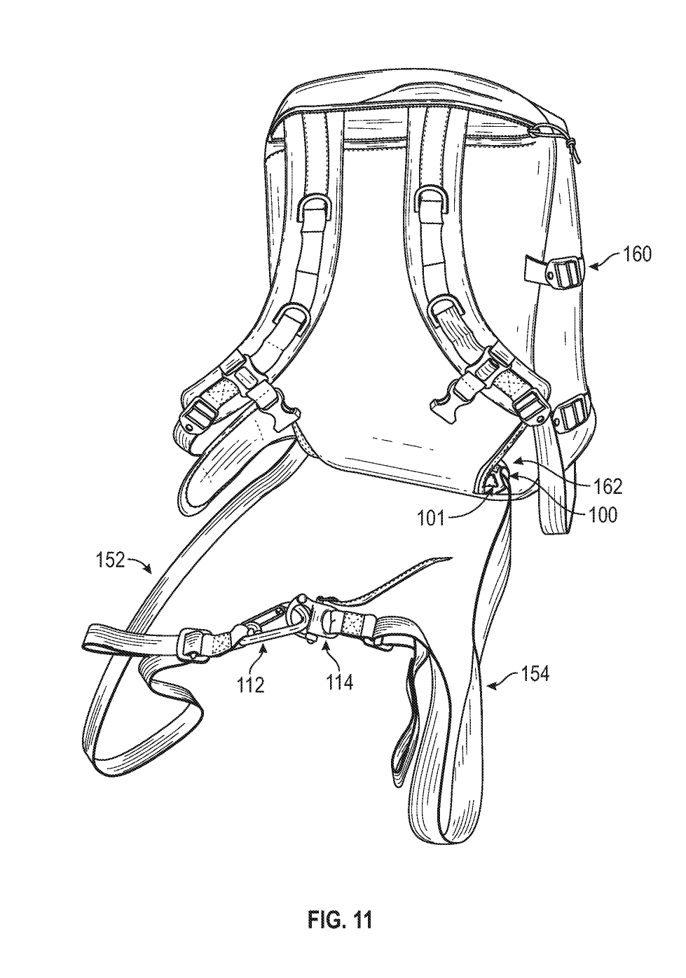

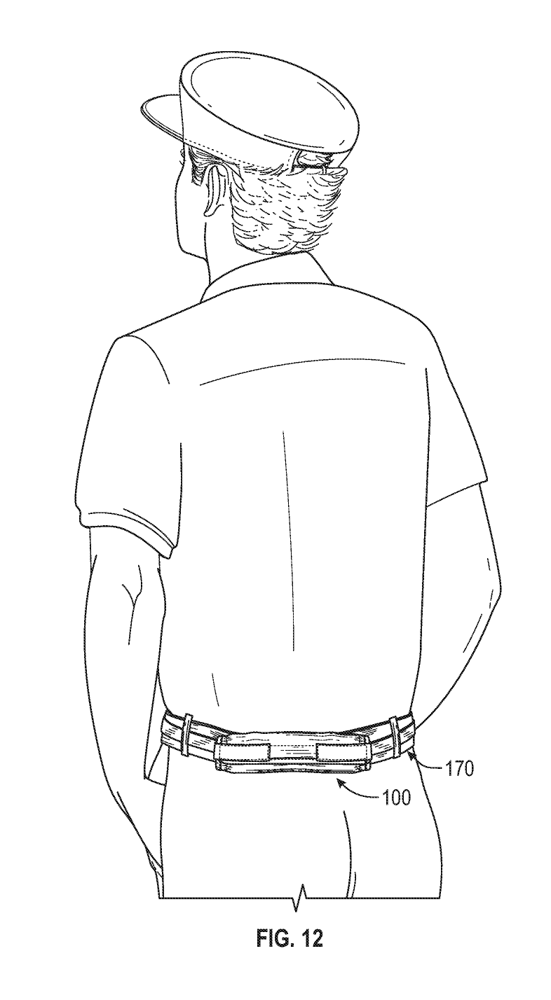

Referring now to FIGS. 11 and 12, in this and other embodiments, TERA 100 can be integrated into various types of clothing, gear or other items worn by law enforcement, firefighters, military personnel, and others. For example, FIG. 11 illustrates TERA 100 integrated into a backpack 160. In this example, a portion of base 101 of TERA 100 can simply be slipped/disposed in lower backpack pocket 162 and/or stitched into position to the backpack 160. In another example, FIG. 12 illustrates TERA 100 integrated into a gun belt 170.

Advantages of the TERA 100 over the rescue assembly of WO2016/166606 include, but are not limited to, the following.

The TERA 100 is quicker and easier to deploy because ends of the rescue strap 110 are not fastened into the ends of the base 101. In contrast, with the right 103 and left 104 graspable handle members/wings of rescue strap 110 detachable/attachable to the outside of the base 101 and with the right 103 and left 104 graspable handle members/wings of rescue strap 110 extending out of the sides of the base 101, the rescue strap 110 is more easily gripped and deployed by the rescuer.

The TERA 100 is much easier to pack compared to rescue assembly of WO2016/166606. Instead of having to carefully fold the rescue strap 110, especially so that ends of the rescue strap 110 are in position for hook and loop fasteners at the end of the rescue strap 110 and at ends of the base match up, the rescue strap 110 can be quickly bunched together, placed in the open base 101 as shown in FIG. 3 then the flap 116 is placed over the rescue strap 110 and the base 101 is quickly and easily rolled together, like rolling a burrito.

The snap shackle 118 and release mechanism 120 at the longitudinal end 119 of the base 101 of the TERA 100 ensures that the quick de-coupling mechanism falls out of the side of the base 101 during use so that the rescuer can easily and readily locate the pull cord 122 and operate the quick de-coupling mechanism in an emergency, allowing the rescuer to quickly de-couple the rescue strap 110 from the base 101 and, thereby, the rescuer.

The TERA 100 can be integrated into various types of clothing, gear or other items worn by law enforcement, firefighters, military personnel, and others such as, but not limited to backpack 160 (FIG. 11), and gun belt 170 (FIG. 12).

A number of illustrative embodiments have been described. Nevertheless, it will be understood that various modifications may be made without departing from the spirit and scope of the various embodiments presented herein. For example, the length of the rescue straps, e.g., rescue straps 110 or 210 can be chosen as desired; relatedly, a TERA can be provided in various pre-configured sizes, e.g., small, medium or large to accommodate the size of the rescuer and the intended rescuees. Similarly, the width of the rescue strap can be chosen as desired. Flexible hook-and-loop fastening components have been described herein for the purpose of retaining the rescue strap 110/210 within base 101/201 and to keep the base 101 closed in a deployable configuration. However, it should be understood that any other type of fastening material, mechanism or component can be used as an alternative to accomplish the same or similar functionality.

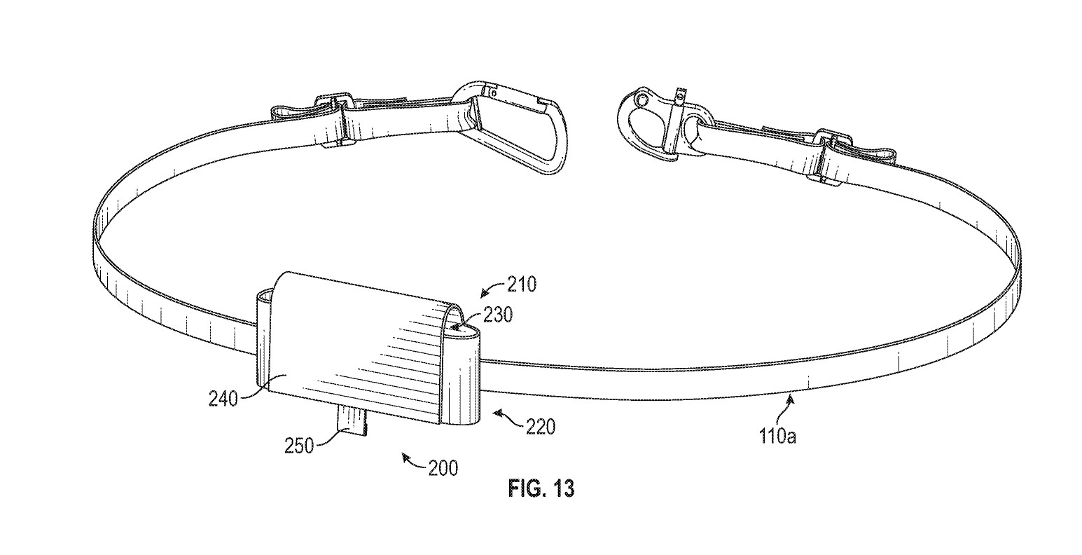

With reference to FIG. 13, another embodiment of a tactical extrication and rescue assembly (TERA) 200 will be described. Similar elements to the TERA 100 described above with respect to FIGS. 1-12, are shown and/or described with the same reference number, but include an “a” suffix. The description of the elements shown and described with respect to FIGS. 1-12 are incorporated herein and will not be described in further detail. The TERA 200 includes a pouch 210 with a base 220 with at least one mounting element for securing the base member to an article of clothing or gear. The base includes a recess 230 and a protective flap 240 that covers the base 220. The flap 240 has a pull tab 250. The rescue strap 110a is normally carried in the recess 230 of the pouch 210. During use, the flap 240 of the pouch 210 is opened and the rescue strap 110a is deployed and used in a manner similar to that shown and described above with respect to FIGS. 1-12. The TERA 200 is much smaller and more compact than the TERA 100.

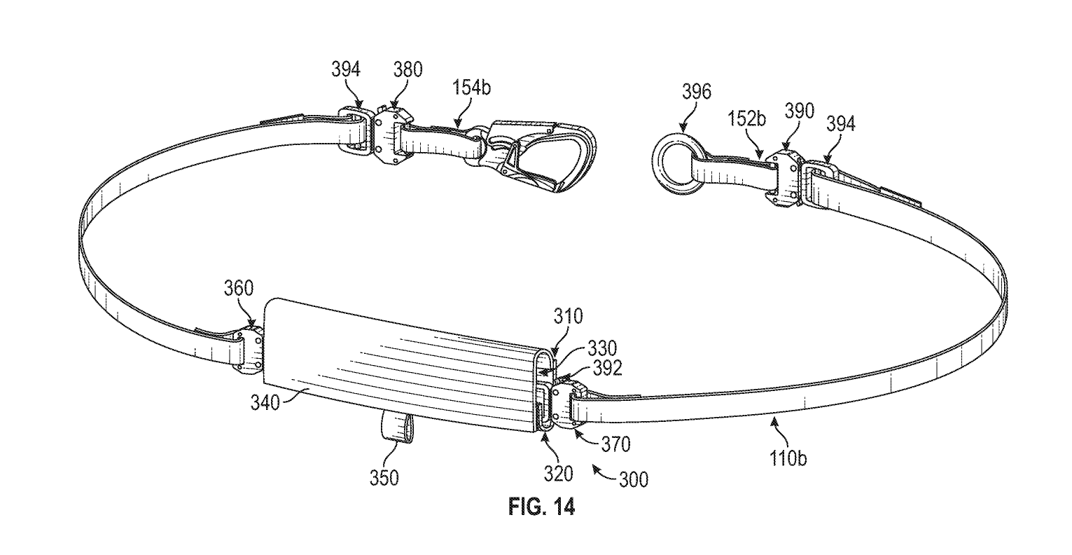

With reference to FIG. 14, a further embodiment of a tactical extrication and rescue assembly (TERA) 300 will be described. Similar elements to the TERAs 100, 200 described above with respect to FIGS. 1-13, are shown and/or described with the same reference number, but include an “b” suffix. The description of the elements shown and described with respect to FIGS. 1-13 are incorporated herein and will not be described in further detail. The TERA 300 includes an elongated pouch 310 with a base 320 with at least one mounting element for securing the base member to an article of clothing or gear. The base 320 includes a recess 330 and a protective flap 340 that covers the base 320. The flap 340 has a pull tab 350. The rescue strap 110b is normally carried in the recess 330 of the pouch 310. The rescue strap 110b includes modular attachment members 360, 370, 380, 390. Modular attachment members 360, 370 are used to attach proximal ends of the rescue strap 110b to connection members 392 at opposite ends of the pouch 310. Modular attachment members 380, 390 attach to connections members 394 of right end portion 152b and left end portion 154b to attach right end portion 152b and left end portion 154b to the rest of the rescue strap 110b. In the embodiment shown, right end portion 152b includes a loop 396 instead of snap shackle 114. During use, the flap 340 of the pouch 310 is opened and the rescue strap 310a is deployed and used in a manner similar to that shown and described above with respect to FIGS. 1-13. The modular attachment members 360, 370, 380, 390 allow the rescue strap 110b and/or the right end portion 152b and left end portion 154b to be easily attached/detached with respect to the rest of the TERA 300.

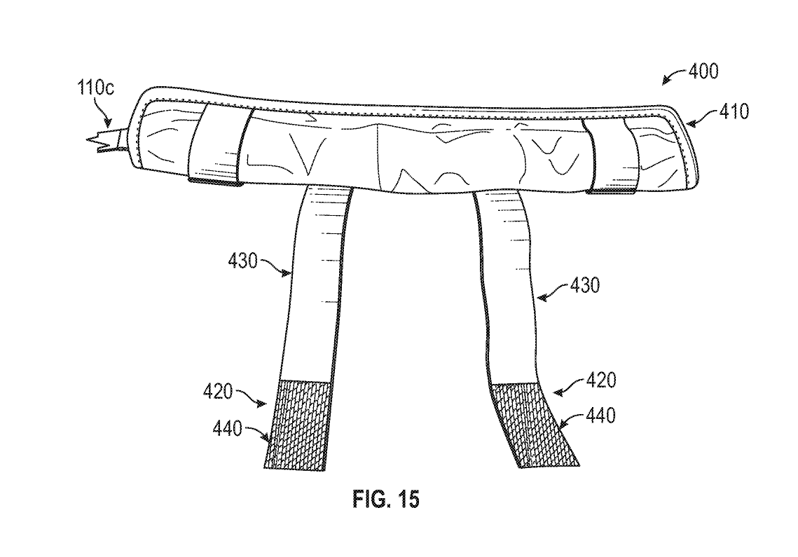

With reference to FIG. 15, a further embodiment of a tactical extrication and rescue assembly (TERA) 400 will be described. Similar elements to the TERAs 100, 200, 300 described above with respect to FIGS. 1-14, are shown and/or described with the same reference number, but include a “c” suffix. The description of the elements shown and described with respect to FIGS. 1-14 are incorporated herein and will not be described in further detail. The TERA 400 includes a base 410 that carries the rescue strap 110b, which is used in a manner similar to that shown and described above with respect to FIGS. 1-14. The base 410 includes one or more (e.g., a pair) attachment mechanisms 420 for attachment of the base 410 to a SCBA assembly (not shown) or other article of clothing or gear. In the embodiment shown, the attachment mechanisms 420 include straps 430 with hook and/or loop fastener strips 440 for attachment to hook and/or loop fastener strip(s) of the SCBA assembly to attach the TERA 400 to the SCBA assembly.

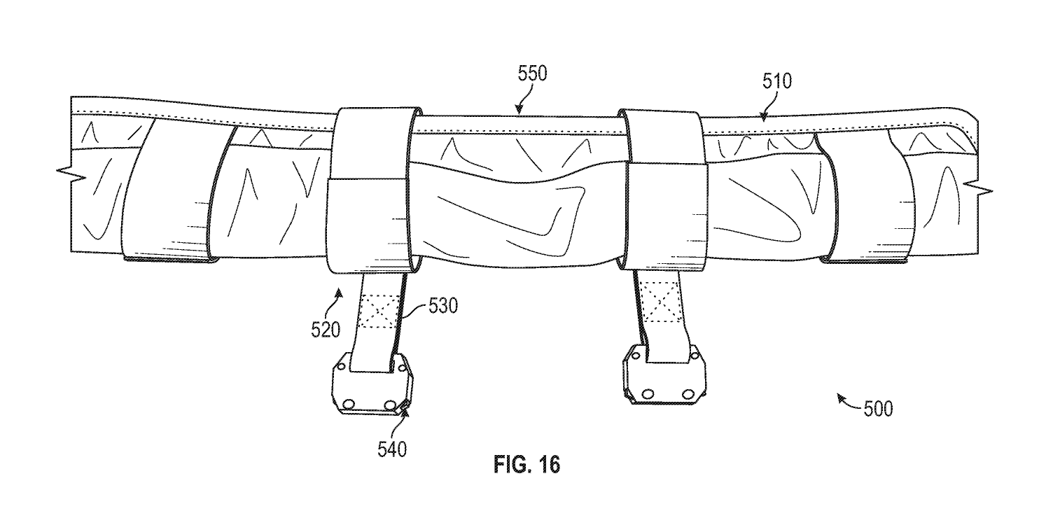

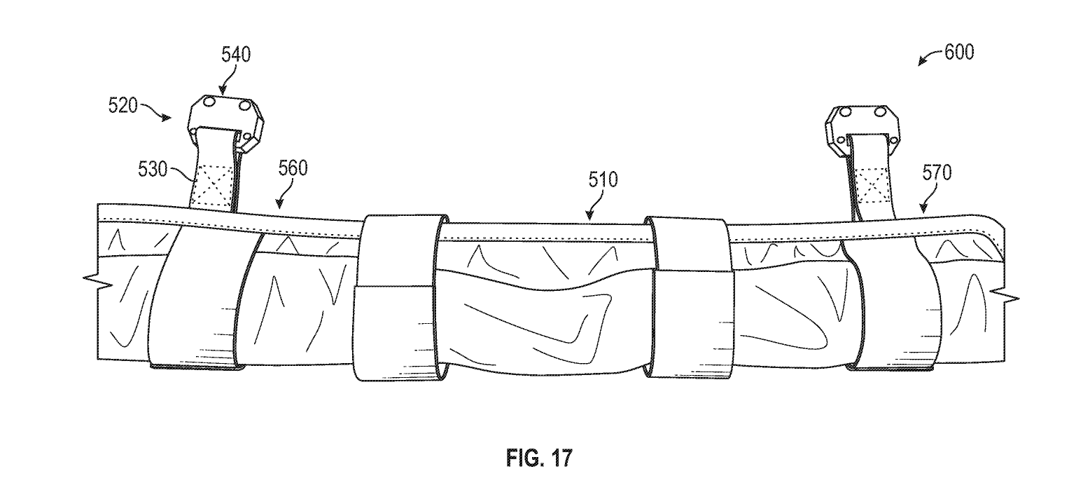

With reference to FIGS. 16 and 17, further embodiments of tactical extrication and rescue assemblies (TERAs) 500, 600 will be described. Similar elements to the TERAs 100, 200, 300, 400 described above with respect to FIGS. 1-14, are shown and/or described with the same reference number, but include a “d” suffix. The description of the elements shown and described with respect to FIGS. 1-15 are incorporated herein and will not be described in further detail. The TERAs 500 include a base 510 that carries the rescue strap, which is used in a manner similar to that shown and described above with respect to FIGS. 1-15. The base 510 includes a pair of attachment mechanisms 520 for attachment of the base 510 to a SCBA assembly (not shown) or other article of clothing or gear. In the embodiment shown, the attachment mechanisms 520 include straps 530 with modular attachment members 540 similar to modular attachment members 360, 370, 380, 390 described above with respect to FIG. 14. The modular attachment members 540 attached connection members (not shown) of a SCBA assembly for attachment of the base 510 to the SCBA assembly or other article of clothing or gear. In the embodiment of the TERA 500 in FIG. 16, the attachment mechanisms 520 are inwardly/centrally disposed in a central section 550 of the base 510. In the embodiment of the TERA 600 in FIG. 17, the attachment mechanisms 520 are laterally outward disposed in outer lateral sections 560, 570 of the base 510.

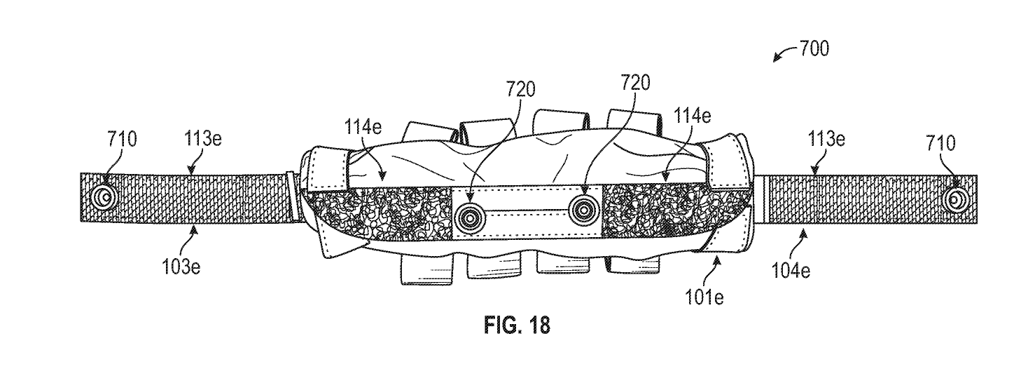

With reference to FIG. 18, a further embodiment of a tactical extrication and rescue assembly (TERA) 700 will be described. Similar elements to the TERAs 100, 200, 300, 400, 500, 600 described above with respect to FIGS. 1-17, are shown and/or described with the same reference number, but include a “e” suffix. The description of the elements shown and described with respect to FIGS. 1-17 are incorporated herein and will not be described in further detail. The TERA 700 is similar to the TERA 100 shown in FIGS. 1-10, but in addition to hook-and-loop fastening material 113e, 114e on left graspable handle member 103e, right graspable handle member 104e, and base 101e, one or more snap connectors 710, 720 are added adjacent ends of hook-and-loop fastening material 113e, 114e of handle members 103e, 104e, and base 101e. The snap connectors 710, 720 help to additionally (in addition to hook-and-loop fastening material 113e, 114e) secure the handle members 103e, 104e to the base 101 when not in use.

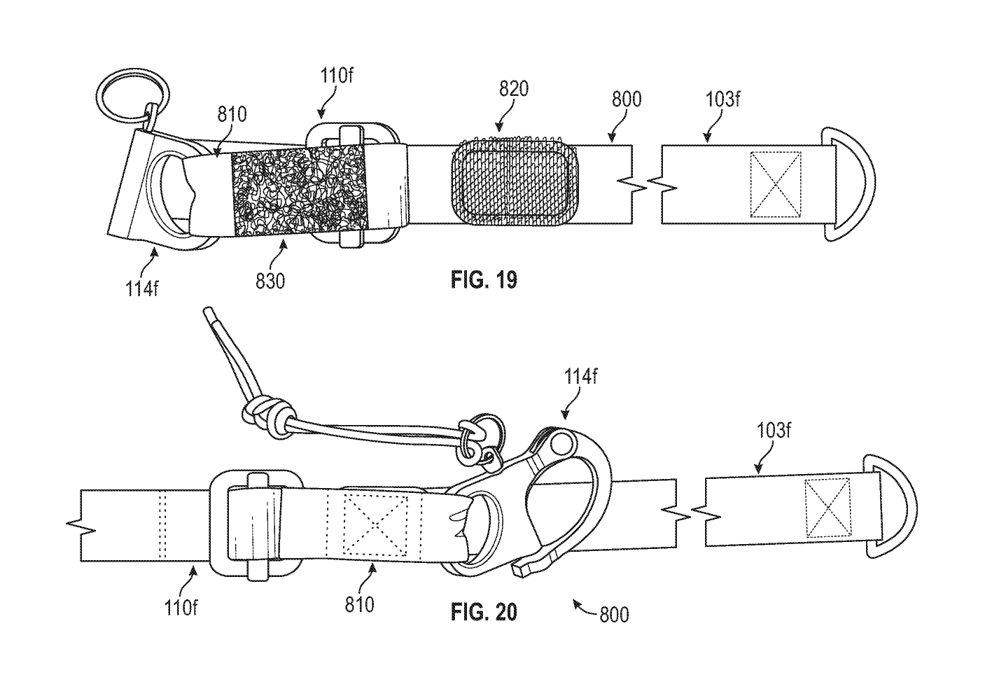

With reference to FIGS. 19 and 20, an embodiment of a deployment and attachment mechanism 800 for a tactical extrication and rescue assembly (TERA) will be described. Similar elements to the TERAs 100, 200, 300, 400, 500, 600, 700 described above with respect to FIGS. 1-18, are shown and/or described with the same reference number, but include a “f” suffix. The description of the elements shown and described with respect to FIGS. 1-18 are incorporated herein and will not be described in further detail. In the deployment and attachment mechanism 800, the graspable handle member 103f and end strap segment 810 of carabineer-type coupler/loop/snap shackle 114f include hook and/or loop fastener strips 820, 830. Similarly, although not shown, the graspable handle member and end strap segment of snap shackle 114f/loop 396 include similar hook and/or loop fastener strips. The hook and/or loop fastener strips 820, 830 allow the graspable handle member 103f and end segment 810 to be attached and deployed adjacent one another when the rescue strap 110f is deployed from the TERA. This way, the carabineer-type coupler/loop/snap shackle 114f is adjacent to the rescuer's hands for quicker/easier coupling of the carabineer-type coupler with loop/snap shackle 114f so that a secure connection to a rescuee is formed for extrication.

In alternative embodiments, the one or more attachment mechanisms of the TERAs shown and/or described herein include one or more magnets in addition to or instead of the one or more attachment mechanisms shown and/or described herein.

In further embodiments, the one or more TERAs are made of composite and/or laminates in addition to or instead of fabric.

While various embodiments of the present invention have been described above, it should be understood that they have been presented by way of example only, and not of limitation. Likewise, the various diagrams may depict an example architectural or other configuration for the disclosure, which is done to aid in understanding the features and functionality that can be included in the disclosure. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present disclosure.

Although the disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus, the breadth and scope of the present disclosure should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent.

As will become apparent to one of ordinary skill in the art after reading this document, the illustrated embodiments and their various alternatives can be implemented without confinement to the illustrated examples.

We claim:

1. A tactical extrication and rescue assembly, comprising:
a base member including at least one mounting element for securing said base member to an article of clothing or gear;
a rescue strap releasably secured to and storable within the base member, the rescue strap including left and right end portions each including a graspable handle member, an end strap segment with a couple member, and a deployment and attachment mechanism that allows the graspable handle member and the end segment to be attached and deployed adjacent to one another when the rescue strap is deployed from the tactical extrication and rescue assembly, enabling the couple members to be adjacent to the rescuer's hands for quicker and easier coupling of the coupling members so that a secure connection to a rescuee is formed for extrication and rescue.

2. The tactical extrication and rescue assembly of claim 1, wherein the coupling members include one or more of a snap shackle, a loop, and a carabiner.

3. The tactical extrication and rescue assembly of claim 1, wherein the base includes a recess that the rescue strap is storable within and a protective flap that covers the base, the protective flap having a pull tab.

4. The tactical extrication and rescue assembly of claim 1, wherein the rescue strap includes a proximal end, and at least one of the base and the proximal end includes a modular attachment member to attach the proximal end of the rescue strap to base.

5. The tactical extrication and rescue assembly of claim 1, wherein the base includes one or more attachment mechanisms to couple the base to one or more of a tactical vest, a firefighter self-contained breathing apparatus (SCBA), firefighter turn-out jacket, MOLLE assembly, belt, and other gear.

6. The tactical extrication and rescue assembly of claim 5, wherein the one or more attachment mechanisms include a strap.

7. The tactical extrication and rescue assembly of claim 5, wherein the one or more attachment mechanisms include at least one of hook fasteners and loop fasteners.

8. The tactical extrication and rescue assembly of claim 5, wherein the one or more attachment mechanisms include a modular attachment member.

9. The tactical extrication and rescue assembly of claim 1, further including one or more snap connectors to releasably secure the graspable handle members to the base.

10. The tactical extrication and rescue assembly of claim 9, further including hook and loop fasteners to releasably secure the graspable handle members to the base.

11. A method of using the tactical extrication and rescue assembly of claim 1, comprising:
storing the rescue strap in the base member when not in use;
deploying the rescue strap from the base member by grasping the handle members of the left and right end portions of the rescue strap and pulling the rescue strap out of the base member so that the graspable handle member and the end segment are attached to one another and deployed adjacent one another when the rescue strap is deployed, enabling the couple members to be adjacent to the rescuer's hands for quicker and easier coupling of the coupling members so that a secure connection to a rescuee is formed for extrication and rescue.
